(19) United States
(12) Patent Application Publication
(10) Pub. No.: US 2008/0161967 A1
(43) Pub. Date: Jul. 3, 2008

(54) ENVELOPE HAVING A DYNAMIC SLOGAN

(75) Inventor: Fabien CHATTE, NOGENT SUR MARNE (FR)

Correspondence Address: SUGHRUE MION, PLLC, 2100 PENNSYLVANIA AVENUE, N.W., SUITE 800, WASHINGTON, DC, 20037, US

(73) Assignee: NEOPOST TECHNOLOGIES, BAGNEUX (FR)

(21) Appl. No.: 11/966,627

(22) Filed: Dec. 28, 2007

(30) Foreign Application Priority Data
Dec. 28, 2006 (FR) 0656022

(51) Int. Cl. G06Q 50/00; G09G 3/30

(52) U.S. Cl. 700/230; 345/76

(57) ABSTRACT

A mail item designed to be franked by a franking machine, in which mail item a slogan zone is constituted by an OLED screen having a control unit that includes memory means for storing various images designed to be displayed on said OLED screen, in still or animated manner, by a control module, said control unit being adapted to be controlled remotely by an external control module via a communications module.

### FIELD OF THE INVENTION

The present invention relates to the field of mail handling, and it relates more particularly to an envelope on which, in particular, a slogan can have various forms, and to a franking machine enabling it to be handled.

### PRIOR ART

The need to inform the public is today present everywhere and thus also on mail items. Businesses feel the need to advertise what they do and their know-how by putting a logo on their envelopes. Conventionally, the logo is present in the “slogan” portion of the postal imprint. It is a graphic that can be relatively complex but that is static in that it is printed once and for all by an ink jet print head at the same time as the postal imprint is printed, and it cannot therefore be altered subsequently.

Unfortunately, the information presented in this way is necessarily limited by the size of the graphic and by its print resolution. One solution for increasing the information is to replace the printed slogan with a holographic element stuck to the envelope. However, in addition to such an element making it possible to view two images only, which images are designed to appear in succession by the observer changing viewpoints, it suffers from having relatively large manufacturing costs. In addition, any change of image requires a new holographic element to be developed.

### OBJECT AND DEFINITION OF THE INVENTION

The present invention thus proposes a mail item whose postal imprint is provided with a device making it possible to display multiple images that form a sort of dynamic slogan. An object of the present invention is also to make it possible to change the images of the slogan without any further development of the device. Another object of the invention is to propose a device that is simple and robust, so as to avoid it being damaged while the mail item is being conveyed, in particular through automatic sorting machines. Another object of the invention is to adapt the device to accommodate the postal imprint in its entirety.

These objects are achieved by a mail item designed to be franked by a franking machine, in which mail item a slogan zone is constituted by an Organic Light Emitting Diode (OLED) screen having a control unit that includes memory means for storing various images designed to be displayed on said OLED screen, in still or animated manner, by a control module, said control unit being adapted to be controlled remotely by an external control module via a communications module.

With this configuration, it becomes possible to obtain a dynamic slogan successively displaying a plurality of different images, the representations of which are chosen by the sender. The same OLED screen can be used for displaying a multitude of distinct images merely by modifying the control of said OLED screen.

Advantageously, said control unit further includes contactless communications means for enabling said OLED screen to be controlled remotely.

Preferably, a franking amount zone and a date zone are also constituted by said OLED screen, thereby making it possible to display a postal imprint in its entirety.

Said mail item is one of the following items: an envelope and a label.

The invention also provides a franking machine comprising franking means for franking a stack of mail items, and conveyor means for conveying said stack of mail items to and from said franking means, wherein said franking means are constituted by contactless communications means for acting, under the control of control and monitoring members, to deliver a plurality of images remotely to a control unit of an OLED screen mounted on each of said mail items to be franked that form said stack, said plurality of images including a postal imprint validating the franking of said mail item.

This novel franking machine making it possible to handle the above-mentioned envelopes thus has no means for selecting the mail items one by one, said mail items being handled in stacks, and has no print means, the franking taking place by remote communication.

### BRIEF DESCRIPTION OF THE DRAWINGS

The characteristics and advantages of the present invention appear more clearly from the following description given by way of non-limiting indication and with reference to the accompanying drawings, in which:

FIG. 1 shows a first embodiment of an envelope provided with a display device of the invention;

FIG. 2 shows the various means making it possible to control the display device of FIG. 1;

FIG. 3 shows a second embodiment of an envelope provided with a display device of the invention;

FIG. 4 shows a novel postage meter or “franking machine” that is specially adapted to handling FIG. 3 envelopes; and

FIG. 5 shows an envelope provided with a postal imprint of the prior art.

### DETAILED DESCRIPTION OF A PREFERRED EMBODIMENT

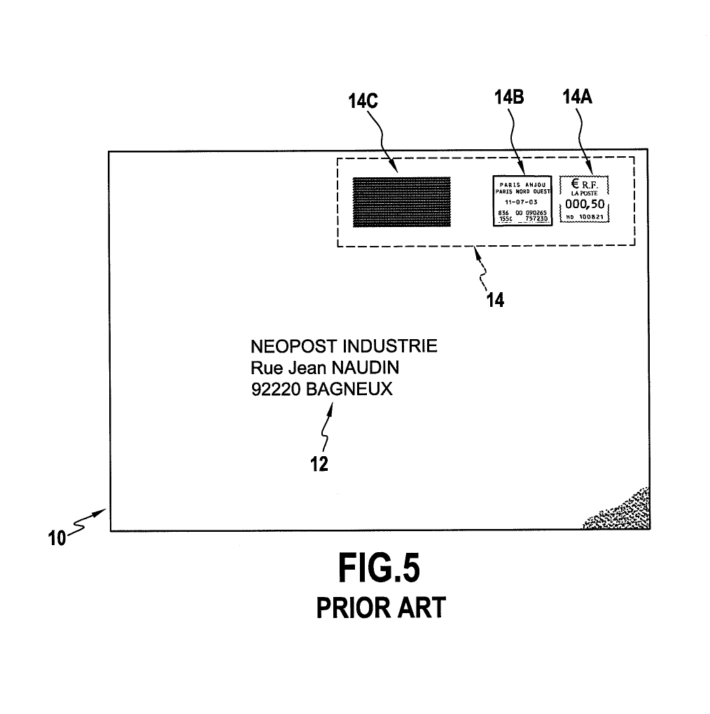

As shown in FIG. 5, showing the prior art, a mail item, e.g. an envelope 10, has two main print zones, namely a zone 12 in which the address is printed and a zone 14 in which the postal imprint is printed. The postal imprint is conventionally itself subdivided into three main zones: a postage amount or “franking amount” zone 14A, a date zone 14B, and a slogan zone 14C. In digital imprints (see, for example, the Information-Based Indicia Program (IBIP) Standard in the United States of America), the two first zones often form a single zone.

As is known, the slogan zone is a zone having a graphic printed at the same time as the other elements of the postal imprint by means of an ink jet print head of a franking machine. Once printed, the slogan cannot be altered and therefore remains unchanged, i.e. static, from the sender to the recipient.

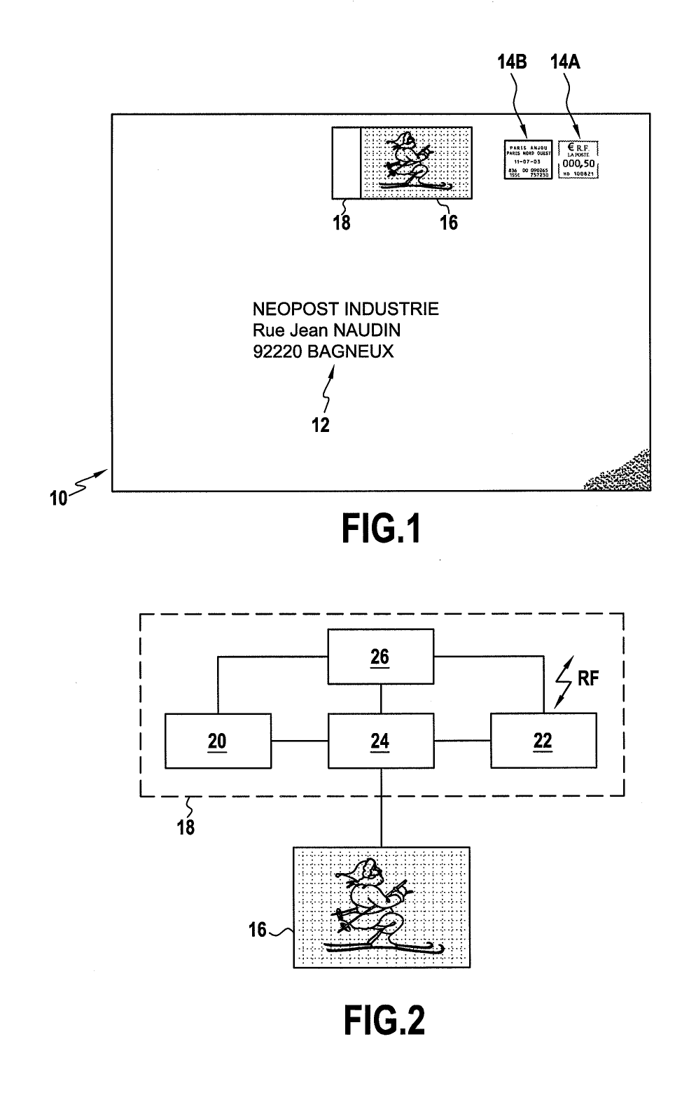

As shown in FIG. 1, the present invention proposes firstly to make said slogan dynamic by replacing the corresponding printed zone with a display 16 associated with a control unit 18. More precisely, this figure showing the envelope 10 also shows the two conventional main zones: the address zone 12 and the print zone for printing the postal imprint, which print zone includes, as above, the franking amount zone 14A and the date zone 14B. However, in accordance with the invention, the slogan zone is no longer a zone that is printed with the remainder of the postal imprint, as it is in the prior art, but rather it is a screen zone formed by the display 16 which is implemented using OLED technology and by its control unit 18. This known technology makes it possible to implement flexible flat-screen displays making it possible to display still or animated black & white or color images with particularly high levels of brightness, of fineness, and of compactness. An OLED screen is constituted by a stack of fine organic layers interposed between a transparent anode and a metal cathode. Because of the way in which they are manufactured, such displays are much less expensive to produce than, for example, conventional LED displays which, in addition, cannot withstand going through a mail handling machine.

FIG. 2 diagrammatically shows the various elements making up the control unit 18 of the OLED screen 16. These elements can be implemented using a conventional semiconductor technology, but they preferably have surface-mount components. The control unit comprises a memory 20 for storing the images that are to be displayed on the device, and various parameters required for such display (order of appearance of the pixels, sequencing of the images, modes of display, etc.), a communications module 22 for downloading the slogan and/or the display parameters, for example, and a control module 24 managing the two above-mentioned elements and controlling the display 16. The memory is advantageously a flash memory, the communications module is advantageously a contactless module (e.g. a Radio-Frequency Identification (RFID) tag) or a wireless module (e.g. a Wireless Universal Serial Bus (WUSB)) communicating by radio-frequency waves with a base module optionally disposed in the franking machine (shown in FIG. 4), and the control module is advantageously a specialized microcontroller or a microprocessor. All of these elements are powered by a battery 26 of the “Power Paper™”, type that has a life that is admittedly of limited length, but that offers the advantage of being light-weight and flexible like the screen itself.

This structure offers great flexibility and thus makes it possible to have various operating modes.

Thus, the envelope of FIG. 1 can be implemented with a conventional franking machine. In this configuration, the OLED screen is activated prior to being inserted into the franking machine at which only the franking amount zone 14A and the date zone 14B are printed. The same applies for the address zone which is conventionally printed earlier at a secretarial workstation of the sender. It is possible for activating the OLED screen, i.e. entering the various items of image data and parameters necessary for displaying the desired logos, to have been performed in the factory directly by the manufacturer of the envelopes in compliance with the wishes of the sender or indeed by the sender in person via a recording station including communications and software means suitable for such entering of the image data and parameters into the memory.

However, the envelope can also be implemented with an improved franking machine which, in addition to the conventional inkjet print means, also includes communications means making it possible to co-operate with the communications means 22 of the control unit of the envelope. The OLED screen is then delivered without images (with a black screen) and is inserted with the envelope into the franking machine, while still not containing any images, the images being transferred into the memory 20 of the control unit in the franking machines while the envelope is being conveyed. This configuration offers the advantage of activating the OLED screen only once the envelope has been franked and thus once it is ready to be sent, unlike the preceding configuration in which, since the activation is performed prior to the franking, a risk can exist of the battery becoming flat.

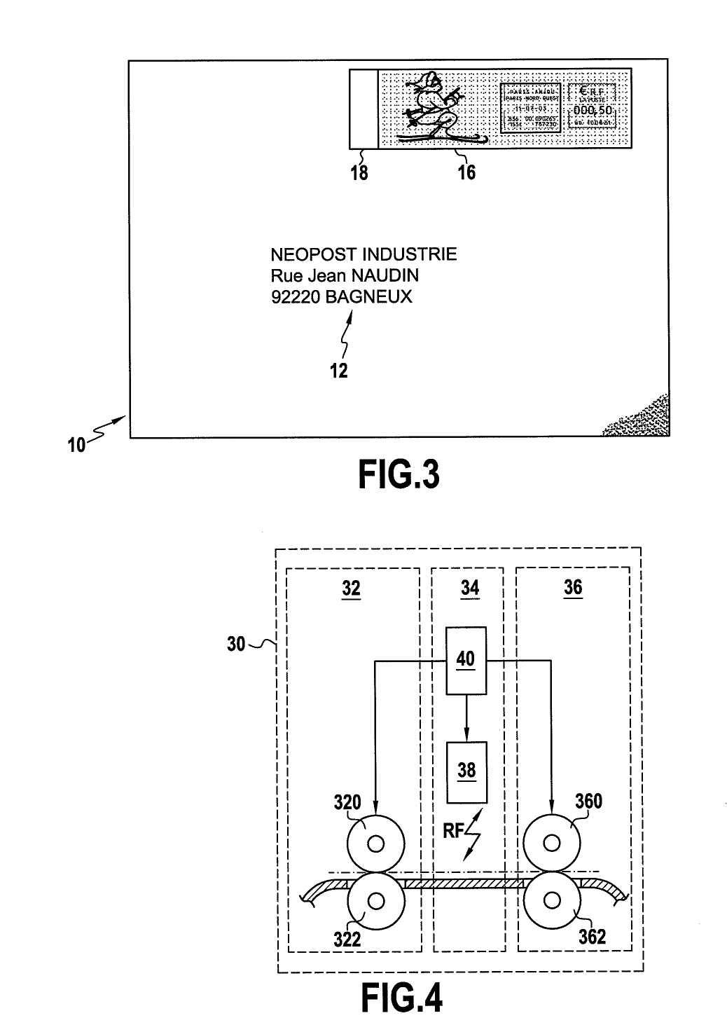

FIG. 3 shows a second embodiment of the invention. In order to operate, the control means of the OLED screen require, as explained above, the presence of a basic module that is preferably incorporated into the franking machine. The inventor takes the view that, since such a module is used, it might as well be used for the entire postal imprint, thereby avoiding having to use the conventional inkjet print module. The envelope 10 obtained in this way thus merely has its address zone 12, the postal imprint zone being replaced with a single display 16 associated with its control unit 18. The image displayed by the OLED screen 16 thus includes a still or static portion corresponding to the franking amount zone and to the date zone, and a variable or dynamic portion corresponding to the slogan zone. In addition, since communication takes place in contactless manner, it is no longer necessary to handle the envelopes one by one and the usual selection means of the franking machine can thus also be omitted, it being possible to handle the envelopes in batches.

The novel franking machine making it possible to handle FIG. 3 envelopes can thus have the configuration shown diagrammatically in FIG. 4.

In the direction in which the mail items advance, said franking machine 30 of the invention comprises upstream conveyor means 32 formed by upstream rollers and backing rollers 320, 322 for conveying a stack of mail items to be franked that are supplied by a feeder (not shown), franking means 34 for franking each mail item of the stack, and downstream conveyor means 36 formed by downstream conveyor rollers and backing rollers 360, 362 for conveying the stack of franked mail items towards a mail storage station (not shown).

The franking means are not, as is known, constituted by inkjet print means but rather they comprise contactless communications means 38 that are designed to co-operate with the communications means 22 of the control unit 18 of the envelope 10 and that are controlled and monitored by control and monitoring means 40 that also manage, as is known, control of the upstream and downstream conveyor means.

This novel machine structure operates as follows. The envelopes whose address zones have already been filled in are inserted in batches into the machine, and are conveyed to the franking module at which the memory of the control unit of each of the envelopes of the stack is loaded via the contactless communications means of the control unit and of the machine, this loading naturally including not only loading the slogan, but also loading the fixed or variable postal data which can be non-encrypted or encrypted and which usually forms the franking amount zone and the date zone. On exiting from the machine, each of the envelopes of the stack of ejected envelopes then has a postal imprint like a conventionally franked envelope with, however, the feature that the postal imprint is not printed but rather it is displayed and that the usually fixed slogan is dynamic with a plurality of still or animated images being displayed. For the postal authorities, such an envelope offers two modes of checking the franking: a conventional mode in which the postal authorities optically read the postal imprint displayed on the screen, and an “electronic” mode in which the postal authorities read the imprint directly from the memory by using communications means similar to those present in the machine.

Naturally, the present invention is not limited to the figures showing one envelope at a time, and the person skilled in the art can supplement those figures without showing any inventive step. For example, the OLED screen of the invention can, naturally, be mounted on a label which can then be stuck to a thick envelope or to a parcel once it has gone through the franking machine.

What is claimed is:

1. A mail item designed to be franked by a franking machine, in which mail item a slogan zone is constituted by an OLED screen having a control unit that includes memory means for storing various images designed to be displayed on said OLED screen, in still or animated manner, by a control module, said control unit being adapted to be controlled remotely by an external control module via a communications module.

2. A mail item according to claim 1, wherein said control unit further includes contactless communications means for enabling said OLED screen to be controlled remotely.

3. A mail item according to claim 1, wherein a franking amount zone and a date zone are also constituted by said OLED screen, thereby making it possible to display a postal imprint in its entirety.

4. A mail item according to claim 1, wherein said mail item is one of the following items: an envelope and a label.

5. A franking machine comprising franking means for franking a stack of mail items, and conveyor means for conveying said stack of mail items to and from said franking means, wherein said franking means are constituted by contactless communications means for acting, under the control of control and monitoring members, to deliver a plurality of images remotely to a control unit of an OLED screen mounted on each of said mail items to be franked that form said stack, said plurality of images including a postal imprint validating franking of said mail item.
